(19) United States
(12) Patent Application Publication
(10) Pub. No.: US 2026/0340318 A1
(43) Pub. Date: Oct. 29, 2026

(54) TRANSLATION METHOD, ELECTRONIC DEVICE, STORAGE MEDIUM, AND TRANSLATION MACHINE

(71) Applicant: AMLOGIC (SHANGHAI) CO., LTD., Shanghai (CN)

(72) Inventors: Tingting Dong, Shanghai (CN); Yayun Ren, Shanghai (CN); Jinhong Zhang, Shanghai (CN)

(21) Appl. No.: 19/287,866

(22) Filed: Aug. 1, 2025

(30) Foreign Application Priority Data
Apr. 29, 2025 (CN) 202510559571.7

(51) Int. Cl. G06F 40/58

(52) U.S. Cl. CPC G06F 40/58

(57) ABSTRACT

A translation method, an electronic device, a storage medium, and a translation machine are disclosed. The translation method includes: obtaining input information from multiple target devices; processing the input information from the multiple target devices in parallel to obtain translated information in target language categories corresponding to the input information from the multiple target devices; and outputting the translated information in the target language categories corresponding to the input information from the multiple target devices in parallel. The method of the present disclosure enables parallel processing and parallel translation output of multi-language information, enhances the multi-language translation function of the translation machine, improves the processing efficiency of the multi-device and the multi-language translation, and thereby enhances the experience of the multi-device synchronous interaction and the cross-language communication.

### CROSS-REFERENCE TO RELATED APPLICATIONS

This application claims priority to and benefits from Chinese Patent Application No.202510559571.7 filed with the China National Intellectual Property Administration on Apr. 29, 2025 and entitled “TRANSLATION METHOD, ELECTRONIC DEVICE, STORAGE MEDIUM, AND TRANSLATION MACHINE”. the entire contents of which are incorporated herein by reference.

### TECHNICAL FIELD

The present disclosure relates to the field of communication and translation technology, and more particularly, to a translation method, an electronic device, a storage medium, and a translation machine.

### BACKGROUND

Against the background of deepening globalization, the demand for cross-language communication is growing rapidly, especially in international business meetings, transnational cooperation, tourism, and multi-language social occasions. Users have higher requirements for real-time and accurate multi-language translation services. However, existing translation machines adopt a serial processing mode, which can only handle input information from one user or device at the same time, making it difficult to meet the needs of simultaneous input from multiple users and parallel translation in multiple languages. This processing method can easily lead to translation delays in multi-party interactions or conference scenarios, affecting the timeliness of information transmission and the experience of cross-language communication.

### SUMMARY

The present disclosure aims to solve at least one of the technical problems existing in the prior art. Therefore, a first objective of the present disclosure is to propose a translation method that can realize parallel processing and parallel translation output of multi-language information, enhance the multi-language translation function of the translation machine, improve the processing efficiency of multi-device and multi-language translation, and thereby improve the experience of multi-device synchronous interaction and cross-language communication.

A second objective of the present disclosure is to propose an electronic device.

A third objective of the present disclosure is to propose a computer-readable storage medium.

A fourth objective of the present disclosure is to propose a translation machine.

To achieve the above objectives, a translation method according to an embodiment of a first aspect of the present disclosure includes: obtaining input information from multiple target devices; processing the input information from the multiple target devices in parallel to obtain translated information in target language categories corresponding to the input information from the multiple target devices; and outputting the translated information in the target language categories corresponding to the input information from the multiple target devices in parallel.

The translation method according to the embodiment of the present disclosure, by obtaining input information from the multiple target devices, simultaneous collection of multi-language input data is achieved. Then, parallel processing technology, deep learning models, and translation models are used to perform real-time language recognition and translation on the input information from the multiple target devices, ensuring that all the input information can be simultaneously converted into translation results corresponding to the target language categories respectively. These translation results are synchronously transmitted back to their target devices respectively through a parallel output mechanism, avoiding the time delays caused by one-by-one traditional serial processing method. This parallel processing method ensures that multi-language information can be processed efficiently and in real-time, and ultimately achieves synchronous translation output among the multiple devices, which enhances the multi-language translation function of the translation machine, improves the processing efficiency of multi-device and multi-language translation, and thereby enhances the experience of multi-device synchronous interaction and cross-language communication.

In some embodiments, the outputting the translated information in the target language categories corresponding to the input information from the multiple target devices in parallel includes: outputting the translated information through a split screen or multiple sound channels.

In some embodiments, the translation method further includes: obtaining an input language category corresponding to the input information from each of the multiple target devices; automatically translating feedback information in the target language category into information in a target input language category, and sending the information in the target input language category to a target device corresponding to the target input language category.

In some embodiments, the obtaining the input language category corresponding to the input information from each of the multiple target devices includes: extracting text information in the input information through a deep learning model and determining the input language category corresponding to the input information based on the text information.

In some embodiments, the translation method further includes: sending the information in the target input language category to the target device corresponding to the target input language category in at least one of text, picture, or voice.

In some embodiments, the input information from the multiple target devices is multi-modal information.

In some embodiments, the translation method further includes: sending the translated information to a target receiving device, the target receiving device including the target device and/or another communication terminal.

In some embodiments, the target device includes at least one of a mobile terminal and a wearable device.

To achieve the above objectives, an electronic device according to an embodiment of a second aspect of the present disclosure includes: at least one processor; and a memory in communication connection with the at least one processor. The memory stores a computer program executable by the at least one processor, the computer program when executed by the at least one processor implements the translation method according to any of the above embodiments.

In the electronic device according to the embodiment of the present disclosure, the at least one processor executes the computer program implementing the translation method described in any of the above embodiments. By obtaining the input information from the multiple target devices, simultaneous collection of multi-language input data is achieved. Then, parallel processing technology, deep learning models, and translation models are used to perform real-time language recognition and translation on the input information from each target device, to ensure that all the input information can be simultaneously converted into translation results corresponding to the target language categories respectively. These translation results are synchronously transmitted back to the respective target devices through the parallel output mechanism, avoiding the time delay caused by one-by-one translation in the traditional serial processing method. This parallel processing method ensures that multi-language information can be processed efficiently and in real-time, and ultimately achieves synchronous translation output among multiple devices, enhancing the multi-language translation function of the translation machine, improving the processing efficiency of multi-device and multi-language translation, and thereby enhancing the experience of multi-device synchronous interaction and cross-language communication.

To achieve the above objectives, a computer-readable storage medium according to an embodiment of a third aspect of the present disclosure stores a computer program, and the computer program when executed by the processor implements the translation method according to any of the above embodiments.

According to the computer-readable storage medium of the embodiment of the present disclosure, by adopting the translation method according to the above embodiments, parallel processing and parallel translation output of multi-language information can be achieved, the multi-language translation function of the translation machine can be enhanced, the processing efficiency of multi-device and multi-language translation can be improved, and thereby the experience of multi-device synchronous interaction and cross-language communication can be enhanced.

To achieve the above objectives, a translation machine according to an embodiment of a fourth aspect of the present disclosure includes: a receiving module configured to receive input information; a processing module connected to the receiving module and configured to perform the translation method according to any of the above embodiments.

In the translation machine according to the embodiment of the present disclosure, the processing module executes the translation method according to any of the above embodiments. By obtaining the input information from the multiple target devices, simultaneous collection of multi-language input data is achieved. Then, parallel processing technology, deep learning models, and translation models are used to perform real-time language recognition and translation on the input information from each target device, to ensure that all the input information can be simultaneously converted into translation results corresponding to the respective target language categories. These translation results are synchronously transmitted back to the respective target devices through the parallel output mechanism, avoiding the time delay caused by one-by-one translation in the traditional serial processing method. This parallel processing method ensures that multi-language information can be processed efficiently and in real-time, and ultimately achieves synchronous translation output among multiple devices, enhancing the multi-language translation function of the translation machine, improving the processing efficiency of multi-device and multi-language translation, and thereby enhancing the experience of multi-device synchronous interaction and cross-language communication.

In some embodiments, the processing module includes: an artificial intelligence unit configured to perform speech recognition on the input information to extract the text information in the input information and determine the input language category corresponding to the input information based on the text information; and a local translation unit configured to obtain the translated information in the target language categories corresponding to the input information, and automatically translate feedback information in the target language category into information in a target input language category.

In some embodiments, the processing module further includes: an output module connected to the processing module and configured to output the translated information.

In some embodiments, the processing module further includes: a communication module connected to the processing module and configured to send the translated information.

The additional aspects and advantages of this disclosure will be partially provided in the following description, and partially will become apparent from the following description, or will be learned through the practice of this application.

### BRIEF DESCRIPTION OF DRAWINGS

The above and/or additional aspects and advantages of the present disclosure will become apparent and easy to understand from the description of embodiments in conjunction with the accompanying drawings, in which:

FIG. 1 is a flowchart of a translation method according to an embodiment of the present disclosure;

FIG. 2 is a schematic diagram of a translation processing flow according to an embodiment of the present disclosure;

FIG. 3 is a block diagram of an electronic device according to an embodiment of the present disclosure;

FIG. 4 is a block diagram of a translation machine according to an embodiment of the present disclosure.

### REFERENCE NUMERALS

Translation machine 100;

Receiving module 1; Processing module 2; Output module 3; Communication module 4;

Artificial intelligence unit 21; Local translation unit 22;

Electronic device 200;

Processor 201; Memory 202.

### DESCRIPTION OF EMBODIMENTS

The following is a detailed description of embodiments of the present disclosure, and the embodiments described with reference to the accompanying drawings are exemplary. The embodiments of the present disclosure will be described in details.

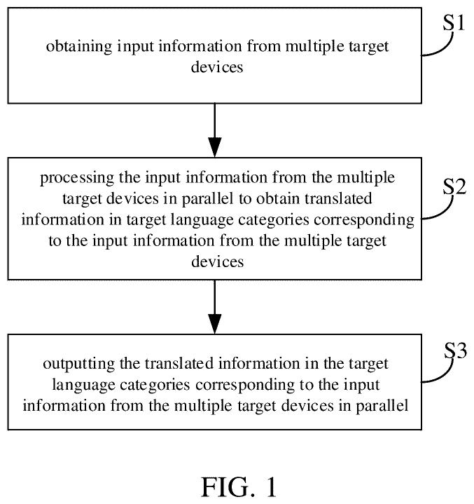

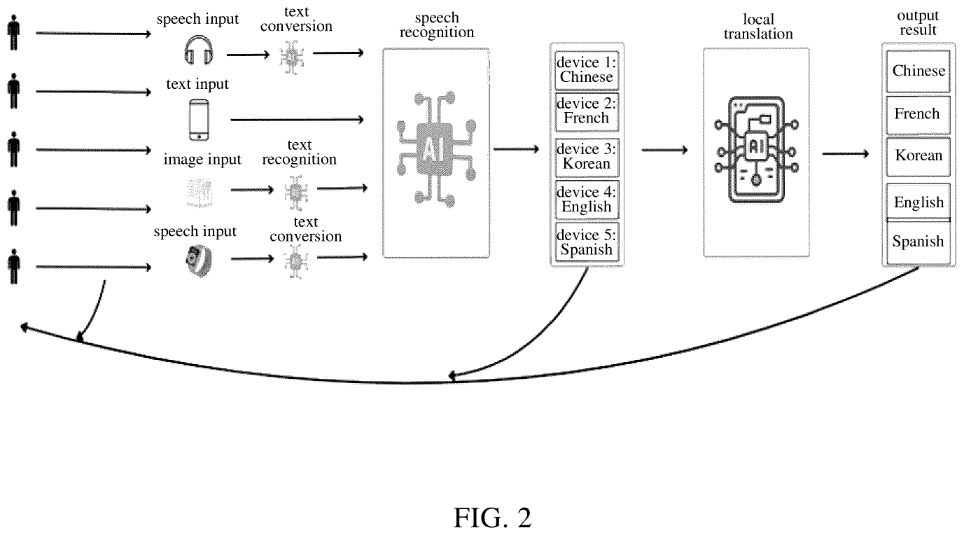

With reference to FIG. 1 to FIG. 2, a translation method according to an embodiment of the present disclosure is described below. The translation method is applied to a translation machine. The translation machine may be a hardware device or a translation program or application implemented based on software. The translation machine in hardware form can connect to multiple target devices via wired or wireless means (such as Wi-Fi, Bluetooth, or 5G network). The translation machine in software form can run directly on multiple target devices to achieve parallel processing and translation output of multi-language information, and thereby improve the experience of multi-device synchronous interaction and cross-language communication.

FIG. 1 is a flowchart of a translation method according to an embodiment of the present disclosure. As shown in FIG. 1, the translation method of the embodiment of the present disclosure at least includes steps S1-S3.

At S1, input information from multiple target devices is obtained.

In some embodiments, the form of the input information may include, but is not limited to: speech input, text input, image input, and video input. The speech input may be speech information obtained by utilizing a microphone or an audio input device on the device. The text input may be text information obtained by means of a text input box, a text message, an email, or uploading a text file. The image input may be information with text that is obtained by taking a picture with text via the camera of the device or selecting a picture with text from a gallery for uploading. The video input may be a video with subtitles obtained by recording or uploading to obtain text or speech information contained in the video.

In some embodiments, as shown in FIG. 2, the target device may include, but is not limited to: headphones with microphones, smartphones, tablets, laptops, smartwatches, and other wearable devices.

At S2, the input information from the multiple target devices is processed in parallel to obtain translated information in target language categories corresponding to the input information from the multiple target devices.

Specifically, parallel processing technologies such as multi-threading, batch processing, or distributed computing are used to synchronously process the input information of different target devices, ensuring that input information of different target devices can be processed simultaneously, thereby improving translation efficiency. Then, a pre-trained translation model is used to perform real-time translation of each input information to obtain translated information in target language categories corresponding to the input information from the multiple target devices.

At S3, the translated information in the target language categories corresponding to the input information from the multiple target devices are outputted in parallel.

Specifically, a multi-channel transmission mechanism is used to synchronously push translation results to the multiple target devices, enabling real-time reception by users of different terminals. According to the type of the target device, the translation result can be converted into corresponding output format. For example, the translation machine converts the translation result of the speech input into speech data of the target language category and plays it through a speaker or the target device, which applies to conference scenarios to achieve synchronous output of multi-language voices. The translation machine can push the translated text result to a text window to achieve synchronous display of multi-user and multi-language information, which is applicable to scenarios such as cross-national team collaboration or cross-language real-time chatting. The translation machine can overlay translation result in the form of subtitles on a video stream to achieve real-time presentation of multi-language subtitles, which is suitable for scenes such as cross-language conferences, international forums, or live video streaming.

According to the translation method of the embodiment of the present disclosure, by obtaining input information from the multiple target devices, simultaneous collection of multi-language input data is achieved. Then, parallel processing technology, deep learning models, and translation models are used to perform real-time language recognition and translation on the input information from the multiple target devices, ensuring that each input information can be simultaneously converted into translation results corresponding to the target language categories. These translation results are synchronously transmitted back to their each of the target devices through a parallel output mechanism, avoiding the time delays caused by one-by-one translation in the traditional serial processing method. This parallel processing method ensures that multi-language information can be processed efficiently and in real-time, and ultimately achieves synchronous translation output among the multiple devices, which enhances the multi-language translation function of the translation machine, improves the processing efficiency of multi-device and multi-language translation, and thereby enhances the experience of multi-device synchronous interaction and cross-language communication.

In some embodiments, the outputting the translated information in the target language categories corresponding to the input information from the multiple target devices in parallel includes: outputting the translated information through a split screen or multiple sound channels.

The split screen output may refer to presenting translated information from different target devices or of different language categories in different screen areas on the same display device. The split screen can be vertical split screen (e.g., displaying translation results from different target devices or of different language categories in upper and lower or left and right areas respectively), grid split screen (e.g., dividing the screen into multiple areas, the areas displaying different translation results respectively), or dynamic split screen (e.g., automatically adjusting the ratio of the screen division according to the number of target devices and translation language categories to optimize the display of information).

Specifically, when the split screen output is used, the translation machine divides the translated text or subtitles into multiple areas, each area corresponding to a target language. For example, in a conference scenario where different participants use different languages, the translation machine can divide the translation results for these languages into a number of windows on the same screen, with the text information of the corresponding languages being displayed in the windows, so that the translation results of all languages can be simultaneously and intuitively presented on a single screen, realizing synchronous reading and interaction in multiple languages.

In some embodiments, multi-channel output may refer to outputting translated information from different target devices or of target language categories through different audio channels. When using multi-channel output, the translation machine outputs translated speech data through different audio channels respectively. Each audio channel can correspond to a specific target language, ensuring that in conferences or multi-language video calls, the speech translations in different languages can be played independently through different speakers or headphones, avoiding interference caused by mixed sounds. For example, the translation machine can transmit the speech translation results to connected audio devices respectively, and use an audio processing module to separate the signals of these language and then output them through the multiple channels, ensuring each participant receives clear and independent speech translation.

In some embodiments, for international conferences, participants from different countries can wear headphones with different audio channels to receive translated information in their corresponding languages, and realize seamless communication. For multi-language movie/video playback, audiences can select different audio tracks to receive translated information conforming to their languages respectively. For VR (Virtual Reality)/AR (Augmented Reality) immersive experiences, users in multi-language environments can choose to listen to audio streams in different languages, achieving a more natural immersive interaction.

Therefore, this split screen and multi-channel output mode not only ensures the synchronicity and independence of the translated information but also greatly enhances the real-time and user experience of cross-language communication, so that the users of each target device can obtain clear and interference-free translated content according to their own language needs.

In some embodiments, the translation machine of the present disclosure is suitable for multi-language conference translation. Specifically, the translation machine can simultaneously translate the speech of multiple speakers. Unlike existing serial translation technologies, the present disclosure can simultaneously process input and output in multiple languages without the need for translating them one by one in sequence. In addition, the translation results are output through the split screen or the multiple audio channels. Compared to existing technologies that can only process the speech of speakers one by one, this translation machine suitable for multi-language conference translation can significantly improve the synchronous efficiency of multi-language conferences.

In some embodiments, the translation machine of the present disclosure is also suitable for conferences and seminars. Specifically, multiple participants in a discussion, may express opinions or interject simultaneously, requiring the translation machine to distinguish and translate each person's speech in real-time, which is particularly important in international conferences and cross-language team collaborations.

In some embodiments, the translation machine of the present disclosure is also suitable for customer service centers. Specifically, multiple customer service personnel may converse with different customers simultaneously, and an automated translation machine can help customer service personnel to handle multi-language inquiries in real-time, improving efficiency.

In some embodiments, the translation machine of the present disclosure is also suitable for guided tour services. Specifically, in multi-language guided tour service places such as museums or scenic spots, tour guides or staff may need to answer questions from tourists of different languages simultaneously. The translation machine needs to translate the speech inputs of multiple people in parallel in order to respond to the demand quickly.

In some embodiments, the translation machine of the present disclosure is also suitable for group discussions and remote teaching. Specifically, in school group discussions or remote education, students may ask questions or communicate simultaneously. multi-language parallel translation can better support classroom interaction, and ensure that everyone's language is understood.

In some embodiments, the translation method further includes: obtaining an input language category corresponding to the input information from each of the multiple target devices, and automatically translating feedback information in the target language category into information in a target input language category, and sending the information in the target input language category to a target device corresponding to the target input language category.

In some embodiments, in multi-language communication scenarios, it is not sufficient to accomplish unidirectional translation, but it is also necessary to ensure that feedback information is correctly transmitted back to the original language user to form a complete communication loop. The feedback information of the target language category may refer to the fact that in two-way communication, the translation machine generates or processes corresponding translation results according to the input information after receiving the input information from one end, and then returns these results to the information sender in the form of feedback. The feedback information may include the following two situations.

First, in this case, the translation machine first recognizes and translates the input information from the target device, then feeds the translation results back to the source device of the input information. For example, in an international conference, participant A speaks in English, which the translation machine automatically translates into other target languages. At the same time, when participant B replies in their native language (e.g., Chinese), the translation machine can automatically translate B's Chinese reply back into English and feed it back to participant A. Here, the feedback information is the automatic translation reply generated by the translation machine based on the input information.

Second, feedback of information directly input in the native language. In some cases, the target device may directly input information in the native language (e.g., a user directly inputs commands or comments on the translation machine). The translation machine transmits this information in the target language category as feedback directly to the corresponding device. For example, in some intelligent customer service scenarios, the user can directly input a question in the native language, and the customer service system translates the question into the customer service working language. The customer service then responds, and the response content is automatically translated back into the user's input language and is then feedback to the user.

In some embodiments, the obtaining the input language category corresponding to the input information from each of the multiple target devices includes: extracting text information in the input information through a deep learning model and determining the input language category corresponding to the input information based on the text information.

Specifically, the translation machine receives the input information from the target device, which may exist in various forms, such as speech, image, or video. For speech input, the translation machine first converts the speech into text using Automatic Speech Recognition (ASR). For image or video input, Optical Character Recognition (OCR) technology can be used to extract embedded text from it. Regardless of the input form, the key is to convert the input information into standardized text data.

Further, the translation machine processes the extracted text information using the deep learning model. The deep learning model can use pre-trained language models (e.g., Transformer, BERT) for feature extraction and semantic understanding. By analyzing the grammatical structure, vocabulary distribution, and contextual information of the text, the model determines which language the text belongs to. This step can automatically recognize multiple languages without manual user settings, ensuring high accuracy and real-time determination of the input language category.

Further, the translation machine can mark the recognized input language category and associate it with a subsequent translation task, enabling the translation model to automatically select an appropriate translation strategy or a target language conversion path based on that language information. The user does not need to manually set the input language category.

Further, after the language recognition is completed, the translation machine can pass the input information to the translation model and automatically select the translation language according to the receiving language preset by the user to complete the translation task. This not only realizes the automation and intelligence of the input information processing but also provides an accurate language foundation for subsequent two-way translation and feedback mechanisms.

In some embodiments, the translation method further includes: sending the information in the target input language category to the target device corresponding to the target input language category in at least one of text, picture, or voice.

Specifically, after the translation process is completed, the translation machine can output the translation result in a form suitable for the target device to receive and display according to the characteristics of the target device and user-preset preferences. For example, if the target device is primarily used for text display, the translation result can be sent in text form; if the target device has an image display function, the translation machine can present the translated text information in image form, such as overlaying the translated content on relevant pictures or video frames; for the device supporting speech output, the translation result can be processed via Text-to-Speech (TTS) and can be feedback as speech.

In some embodiments, the translation machine can also dynamically select the output form based on a specific scene. For example, in a conference scene, in order to ensure real-time communication between speakers and listeners, both text and voice forms may be used simultaneously, so that different devices and users can obtain the best interactive experience. Through this multi-modal output method, the present disclosure not only ensures efficient transmission of the translation result but also greatly improves the flexibility and adaptability of cross-device, cross-language communication.

In some embodiments, the input information from the multiple target devices is multi-modal information. That is, the input information can exist simultaneously or alternately in multiple different forms, including but not limited to speech, text, image, and video. Multi-modal input means that the target devices are no longer limited to a single input form but can capture information through multiple sensing methods. For example, in a conference or multi-language communication scene, participants can speak via speech while uploading text notes, taking pictures with text, or recording video clips using smartphones or tablets. This diversified information input method can more comprehensively express communication content, and make up for the shortcomings of a single input method. After unified processing, the multi-modal input information can provide a richer data foundation for subsequent automatic language recognition, translation, and feedback output, thereby improving the accuracy of translation results and the flexibility of application.

In some embodiments, the translation machine of the present disclosure not only supports speech and text input but also has powerful image recognition and translation functions. Users can take pictures of menus, road signs, or documents, and the system will recognize the text in the images and perform translations. Therefore, the translation machine of the present disclosure greatly expands usage scenarios, such as translating menus or signs during travel or translating documents in the workplace.

In some embodiments, the translation method further includes: sending the translated information to a target receiving device, the target receiving device including the target device and/or another communication terminal. The other communication terminal may be a device that has communication capability and is capable of receiving data and performing secondary processing or distribution, for example, a cloud server, a cloud platform, an Internet of Things device, or a remote control terminal.

Specifically, after translation is completed, the translation machine sends the translated information in an appropriate format (text, speech, image, video subtitles, etc.) to the target receiving device via a preset communication protocol (e.g., Wi-Fi, Bluetooth, 5G network, or Internet, etc.). The target receiving device can be a terminal device (e.g., a smartphone, tablet, a smartwatch, or a conference terminal, etc.) directly connected to the translation machine or other terminal (e.g., a personal computer, a server, a cloud server, or a dedicated communication terminal) within the same communication network, so as to realize multi-point distribution and synchronized reception of information. For example, in a transnational conference scenario, the translation machine sends the translation result to each terminal in the conference system through split screen display or multi-channel output, so that the participants can receive the translated information in real-time regardless of which device they use. In an intelligent customer service system, customer service personnel and customers communicate with each other via different devices, and the translated information is synchronously displayed across terminals via cloud push or direct sending, so as to ensure that both parties can realize barrier-free communication. Through this method, the translation method of the present disclosure fully utilizes network communication and multi-terminal collaboration technology, achieves flexible and widespread dissemination of the translated information, and further improves the applicability and interactive experience of the system in multi-device and multi-user scenarios.

In some embodiments, the target device includes at least one of a mobile terminal and a wearable device. The mobile terminal may refer to a portable device such as a smartphone, a tablet computer, a laptop computer, etc., which has perfect network connection, data processing, and display capabilities, and is capable of receiving, processing, and displaying the translated information in real-time. The wearable devices include portable electronics such as smartwatches, smart glasses, fitness bracelets, etc., which are small in size, are worn on the human body, and are equipped with intelligent functions.

In some embodiments, the translation method of the embodiment of the present disclosure supports multi-modal input and output for the characteristics of the mobile terminals and the wearable devices. For example, on smartphones or tablets, users can capture speech via built-in microphones, take images or videos via cameras, and then upload the text, images, and video information to the translation machine. The translation result can be displayed on a large screen in the form of text, speech, or image, making it easy for users to read and listen. In the wearable devices such as smartwatches or smart glasses, the translated information can be output via a small screen or voice broadcast, enabling users to quickly obtain real-time translated content during activities, traveling, or meetings.

In some embodiments, the translation machine of the present disclosure has cooperative capabilities with multiple smart devices, including smartphones, tablets, and smartwatches, and can seamlessly connect with wearable devices such as smart headphones and smart glasses to achieve information sharing between devices.

In some embodiments, the translation method of the embodiments of the present disclosure supports cross-device synchronization, which is suitable for environments with multi-person collaboration and multi-scene transitions, such as corporate meetings or teaching environments. In a large conference, users can simultaneously perform inputting and obtain output through different devices.

In some embodiments, users can choose to receive information from a specific target device to avoid redundancy. For example, in a customer service scenario, customer only receives reply information from the customer service end, while customer service needs to receive information from all customer ends, ensuring effective multi-party communication.

In some embodiments, to improve user privacy protection, the translation machine supports local processing of speech and translation data to ensure the security of data transmission. Compared to most existing translation devices that rely on cloud processing, the present disclosure improves data security through local processing, which is particularly suitable for enterprises or individual users with high privacy requirements. High-quality translation services can be provided even when there is no internet connection, which avoids the limitation that existing devices cannot be used in a network-less state, and is suitable for traveling or scenarios in which access to the internet is unavailable.

In some embodiments, the translation machine of the present disclosure can adjust voice style or translation mode based on user's needs or scenarios to avoid leading to a single and boring interactive experience. For example, some users may want the translation results to be presented in a more formal tone, while other users may prefer a natural, colloquial expression.

In some embodiments, the translation machine of the present disclosure supports text input of any length, is suitable for translating content such as long articles, legal documents, etc., provides flexibility that existing translation devices cannot meet, and is especially suitable for the translation needs of complex or professional document.

In some embodiments, the translation machine of the present disclosure can detect and switch languages in real-time during the translation process, can automatically adapt to the context, and avoid interrupting the translation process due to switching languages.

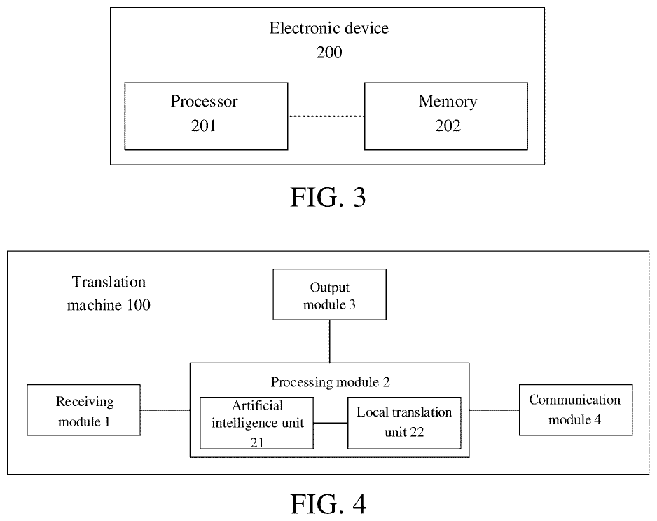

An electronic device according to an embodiment of the present disclosure is described below with reference to FIG. 3.

FIG. 3 is a block diagram of an electronic device according to an embodiment of the present disclosure. As shown in FIG. 3, the electronic device of the embodiment of the present disclosure includes at least one processor and a memory.

In some embodiments, the at least one processor may be one processor or multiple processors such as two processors, three processors, five processors, etc. The processor may be a single-core processor or a multi-core processor and is responsible for executing computer programs to implement functions such as collecting input information, translating, pushing data, displaying results, etc.

In some embodiments, the processor may be a Central Processing Unit (CPU), Graphic Processing Unit (GPU), or Digital Signal Processor (DSP), etc., in the electronic device, and particularly depends on the design and use of the electronic device.

In some embodiments, the memory is a device for storing data and programs, which may be Random Access Memory (RAM), Read-Only Memory (ROM), flash memory, or other storage media. The memory stores translation-related data, computer programs, and intermediate processing results.

In some embodiments, the memory stores a computer program executable by the at least one processor, and the computer program when executed by the at least one processor implements the translation method described in any of the above embodiments.

In the electronic device according to the embodiment of the present disclosure, the at least one processor executes the computer program implementing the translation method described in any of the above embodiments. By obtaining the input information from the multiple target devices, simultaneous collection of multi-language input data is achieved. Then, parallel processing technology, deep learning models, and translation models are used to perform real-time language recognition and translation on the input information from each target device, to ensure that all the input information can be simultaneously converted into translation results corresponding to the target language categories respectively. These translation results are synchronously transmitted back to the target devices respectively through the parallel output mechanism, avoiding the time delay caused by one-by-one translation in the traditional serial processing mode. This parallel processing mode ensures that multi-language information can be processed efficiently and in real-time, ultimately achieving synchronous translation output among multiple devices, enhancing the multi-language translation function of the translation machine, improving the processing efficiency of multi-device and multi-language translation, and thereby enhancing the experience of multi-device synchronous interaction and cross-language communication.

An embodiment of the present disclosure proposes a computer-readable storage medium that stores a computer program, and the computer program when executed implements the translation method described in any of the above embodiments.

The computer-readable storage medium of the embodiment of the present disclosure may include but is not limited to, Phase-Change Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory, or other optical or magnetic storage media, which will not be repeated here.

The computer-readable storage medium according to the embodiment of the present disclosure, by adopting the translation method according to any of the above embodiments, can achieve parallel processing and parallel translation output of multi-language information, enhance the multi-language translation function of the translation machine, improve the processing efficiency of multi-device and multi-language translation, and thereby enhance the experience of multi-device synchronous interaction and cross-language communication.

A translation machine according to an embodiment of the present disclosure is described below with reference to FIG. 4.

FIG. 4 is a block diagram of the translation machine according to an embodiment of the present disclosure. As shown in FIG. 4, the translation machine includes: a receiving module and a processing module.

In some embodiments, the receiving module is configured to receive input information, which may be multi-modal data, including speech, text, image, and video. For example, in a conference scenario, the receiving module can simultaneously receive speech input sent by participants via smartphones or smart headphones, as well as image and text information transmitted via tablets or cameras. The receiving module supports multiple communication protocols (e.g., Wi-Fi, Bluetooth, or 5G) to ensure that data can be transmitted to the translation machine in real time from different sources.

In some embodiments, the processing module is connected to the receiving module and is configured to perform the translation method according to any of the above embodiments. Specifically, the processing module first pre-processes the received input information, such as converting speech to text using Automatic Speech Recognition (ASR) or extracting text from images using Optical Character Recognition (OCR). Then, the processing module automatically detects the input language using a deep learning model, and invokes the corresponding translation model for real-time translation according to the user settings or the automatic recognition results. Finally, the processing module pushes the translation results back to the target device or other communication terminals in form of text, speech, images, or video subtitles through the output methods such as split screen and multi-channel, etc., so as to realize the synchronous interaction among the multiple devices and among the multiple languages.

In the translation machine according to the embodiment of the present disclosure, the processing module executes the translation method according to any of the above embodiments, and achieve simultaneous collection of multi-language input data by obtaining the input information from the multiple target devices. Then, parallel processing technology, deep learning models, and translation models are used to perform real-time language recognition and translation on the input information from each target device, to ensure that all the input information can be simultaneously converted into translation results corresponding to the target language categories respectively. These translation results are synchronously transmitted back to the respective target devices through the parallel output mechanism, avoiding the time delay caused by one-by-one translation in the traditional serial processing mode. This parallel processing method ensures that multi-language information can be processed efficiently and in real-time, and ultimately achieving synchronous translation output among multiple devices, enhancing the multi-language translation function of the translation machine, improving the processing efficiency of multi-device and multi-language translation, and thereby enhancing the experience of multi-device synchronous interaction and cross-language communication.

In some embodiments, as shown in FIG. 4, the processing module includes: an artificial intelligence unit and a local translation unit.

Wherein, the artificial intelligence unit is configured to perform speech recognition on the input information to extract the text information in the input information and determine the input language category corresponding to the input information based on the text information.

Specifically, the artificial intelligence unit is responsible for preliminary processing of input information collected from the target devices. The artificial intelligence unit converts speech input into text using Automatic Speech Recognition (ASR) technology. For image or video input, the text information therein may be extracted in combination with Optical Character Recognition (OCR) technology. The extracted text data is then subject to further processing by the pre-trained deep learning model (e.g., the models based on Transformer or BERT) to automatically determine the language category of the input information by analyzing the text's grammar, vocabulary, and contextual information. This step ensures that the system can accurately recognize the original language of the input information without the need for the user to manually set the input language, providing an accurate language foundation for subsequent translation.

In some embodiments, the local translation unit is configured to obtain the translated information in the target language categories corresponding to the input information, and automatically translate feedback information in the target language category into information in a target input language category.

Specifically, the local translation unit utilizes the input language category determined by the artificial intelligence unit to translate the input information into the predetermined target language category and obtains the corresponding translated information. Simultaneously, the local translation unit has a feedback function, i.e., automatically translating feedback information that is generated by the target language category back to the original input language, thereby realizing two-way language conversion and interaction. For example, in a multi-language conference scenario, the system can translate a participant's speech (e.g., in English) into the target language (e.g., Chinese) and push it to other participants; when other participants reply in Chinese, the local translation unit automatically translates the Chinese feedback back into English and transmits it back to the original speaker, thus ensuring that both parties can communicate in the language they are familiar with.

In some embodiments, as shown in FIG. 4, the translation machine further includes: an output module. The output module is connected to the processing module and is configured to output the translated information.

In some embodiments, the output module may be a display screen or a speech playback module. Specifically, the display screen can display the translated information in the form of text or image, while the speech playback module can convert the translated text into speech output via text-to-speech technology to meet the needs of different users and scenarios.

In some embodiments, the translation machine further includes: a communication module. The communication module is connected to the processing module and is configured to send the translated information.

In some embodiments, the communication module serves as a data transmission bridge between the translation machine and the device. It sends the translated information processed by the processing module in the form of digital data via wired (e.g., Ethernet, USB (Universal Serial Bus)) or wireless (e.g., Wi-Fi, Bluetooth, 5G, etc.) communication methods. In this way, it not only can realize the output of the translated information on a local device (e.g., via the display screen or the speech playback modules) but also be able to push the translated information to the remote device, cloud service, or other terminals via network transmission, so as to realize the information sharing and synchronization cross devices and cross platforms.

In the illustration of this description, an illustration with reference to the terms “one embodiment”, “some embodiments”, “illustrative embodiments”, “an example”, “a particular example” or “some examples” and so on mean that a particular feature, structure, material, or characteristic described in connection with the embodiment(s) or example(s) is included in at least one embodiment or example of the present disclosure. In this description, the exemplary expressions of the above terms do not necessarily specify the same embodiments or examples.

Although embodiments of the present disclosure have been shown and described, it will be understood by those skilled in the art that various changes, modifications, alternations and modifications may be made to these embodiments without departing from the principles and spirit of the present disclosure, the scope of which is defined by the claims and their equivalents.

What is claimed is:

1. A translation method applied to a translation machine comprising:
obtaining input information from multiple target devices;
processing the input information from the multiple target devices in parallel to obtain translated information in target language categories corresponding to the input information from the multiple target devices; and
outputting the translated information in the target language categories corresponding to the input information from the multiple target devices in parallel.

2. The translation method according to claim 1, wherein said outputting the translated information in the target language categories corresponding to the input information from the multiple target devices in parallel comprises:
outputting the translated information through a split screen or multiple sound channels.

3. The translation method according to claim 1, further comprising:
obtaining an input language category corresponding to the input information from each of the multiple target devices;
automatically translating feedback information in the target language category into information in a target input language category, and sending the information in the target input language category to a target device corresponding to the target input language category.

4. The translation method according to claim 3, wherein said obtaining the input language category corresponding to the input information from each of the multiple target devices comprises:
extracting text information in the input information through a deep learning model and determining the input language category corresponding to the input information based on the text information.

5. The translation method according to claim 3, further comprising:
sending the information in the target input language category to the target device corresponding to the target input language category in at least one of text, picture, or voice.

6. The translation method according to claim 1, wherein the input information from the multiple target devices is multi-modal information.

7. The translation method according to claim 1, further comprising:
sending the translated information to a target receiving device, the target receiving device comprising the target device and/or another communication terminal.

8. The translation method according to claim 1, wherein the target device comprises at least one of a mobile terminal and a wearable device.

9. An electronic device, comprising:
at least one processor; and
a memory in communication connection with the at least one processor;
wherein the memory stores a computer program executable by the at least one processor, the computer program when executed by the at least one processor implements operations of:
obtaining input information from multiple target devices;
processing the input information from the multiple target devices in parallel to obtain translated information in target language categories corresponding to the input information from the multiple target devices; and
outputting the translated information in the target language categories corresponding to the input information from the multiple target devices in parallel.

10. The electronic device according to claim 9, wherein said outputting the translated information in the target language categories corresponding to the input information from the multiple target devices in parallel comprises:
outputting the translated information through a split screen or multiple sound channels.

11. The electronic device according to claim 9, wherein the computer program when executed by the at least one processor further implements operations of:
obtaining an input language category corresponding to the input information from each of the multiple target devices;
automatically translating feedback information in the target language category into information in a target input language category, and sending the information in the target input language category to a target device corresponding to the target input language category.

12. The electronic device according to claim 11, wherein said obtaining the input language category corresponding to the input information from each of the multiple target devices comprises:
extracting text information in the input information through a deep learning model and determining the input language category corresponding to the input information based on the text information.

13. The electronic device according to claim 11, wherein the computer program when executed by the at least one processor further implements operations of:
sending the information in the target input language category to the target device corresponding to the target input language category in at least one of text, picture, or voice.

14. The electronic device according to claim 9, wherein the input information from the multiple target devices is multi-modal information.

15. The electronic device according to claim 9, wherein the computer program when executed by the at least one processor further implements operations of:
sending the translated information to a target receiving device, the target receiving device comprising the target device and/or another communication terminal.

16. The electronic device according to claim 9, wherein the target device comprises at least one of a mobile terminal and a wearable device.

17. A computer-readable storage medium storing a computer program, wherein the computer program when executed by the processor implements operations of:
obtaining input information from multiple target devices;
processing the input information from the multiple target devices in parallel to obtain translated information in target language categories corresponding to the input information from the multiple target devices; and
outputting the translated information in the target language categories corresponding to the input information from the multiple target devices in parallel.

18. The computer-readable storage medium according to claim 17, wherein said outputting the translated information in the target language categories corresponding to the input information from the multiple target devices in parallel comprises:
outputting the translated information through a split screen or multiple sound channels.

19. The computer-readable storage medium according to claim 17, wherein the computer program when executed by the processor further implements operations of:
obtaining an input language category corresponding to the input information from each of the multiple target devices;
automatically translating feedback information in the target language category into information in a target input language category, and sending the information in the target input language category to a target device corresponding to the target input language category.

20. The computer-readable storage medium according to claim 19, wherein said obtaining the input language category corresponding to the input information from each of the multiple target devices comprises:
extracting text information in the input information through a deep learning model and determining the input language category corresponding to the input information based on the text information.
